(19) United States
(12) Patent Application Publication
(10) Pub. No.: US 2025/0276905 A1
(43) Pub. Date: Sep. 4, 2025

(54) METHOD FOR RECOVERING OF WASTE HEAT CREATED IN THE PRODUCTION OF GREEN AMMONIA

(71) Applicant: Topsoe A/S, Kgs. Lyngby (DK)

(72) Inventors: Emil Andreas Tjärnehov, Limhamn (SE); Pat A. Han, Smørum (DK)

(73) Assignee: Topsoe A/S, Kgs. Lyngby (DK)

(21) Appl. No.: 18/256,293

(22) PCT Filed: Dec. 13, 2021
(86) PCT No.: PCT/EP2021/085407

§ 371 Date: Jun. 7, 2023

(30) Foreign Application Priority Data
Dec. 17, 2020 (DK) PA 2020 01416

(51) Int. Cl. C01C 1/04; B01D 53/02; C25B 1/04; C25B 9/67; C25B 15/08

(52) U.S. Cl. CPC C01C 1/04; C25B 1/04; C25B 9/67; C25B 15/081; B01D 53/02; B01D 2256/10; B01D 2257/104

(57) ABSTRACT

Method for recovering waste heat created in the production of ammonia, the method comprises the steps of
(a) providing an ammonia synthesis gas including the steps of electrolysis of water or steam for the preparation of hydrogen and of adding a stream of nitrogen into the hydrogen;
(b) converting the ammonia synthesis gas to ammonia;
(c) recovering at least a part of waste heat from the electrolysis in step (a);
(d) upgrading the waste heat from step (c) by heat recovered from one or more compressor stages discharge and/or waste heat created in the conversion of the ammonia synthesis gas in step (b) and/or waste heat from a turbine condenser utilizing steam generated in step (b); and
(e) distributing the upgraded waste heat from step (d) to a downstream heat utilizing step.

The present invention is directed to a method recovering waste heat created in the production of ammonia.

In particular, the invention focuses on waste heat in the green production of ammonia, i.e. preparation of ammonia synthesis gas including water electrolysis driven by sustainable or renewable energy.

Ammonia has been recognized as an excellent energy vector as well as an excellent hydrogen carrier. Liquid ammonia contains more hydrogen than liquid hydrogen.

Ammonia can be produced from air, water and electricity, nearly anywhere in the world where there is access to abundant renewable energy.

Ammonia can then be the energy storage media for renewable energy that is easily transported in bulk amount to different location. Ammonia can be utilized directly in combustion engines/gas turbines or fuel cells or it can be cracked/decomposed into hydrogen and nitrogen. The decomposed ammonia can be fed to a gas turbine or hydrogen can be recovered for fuel cells or other use.

The hydrogen production based on electrolysis will typically generate a significant amount of waste heat due to the efficiency of approximately 60% for conventional technology.

The waste heat from conventional electrolysis is typically available at a low temperature level (approx. 60 deg C.), where it does not have much value. Since more than 90% of the required energy as electricity for ammonia or methanol production is used for the hydrogen production by electrolysis, and approximately 40% of this energy is lost as waste heat, then the amount of waste heat is significant.

The relatively low efficiency of the electrolysis is a major challenge in the production of green electro-fuels. If the waste heat could be transformed into a valuable product, the economic feasibility will be improved.

The production of green ammonia via hydrogen production by electrolysis requires a lot of cooling. This cooling is typical made by circulating cooling water, and the low temperature heat is thus lost.

To improve utilization of waste heat from the electrolysis, this invention provides a method to recover partially or the maximum amount of waste heat from the electrolysis and then upgrade the recovered heat (in hot water) by further heating by recovering process heat from the one or more compressor stages discharge and/or waste heat from the ammonia synthesis and/or optionally a turbine condenser utilizing the steam generated in the synthesis. The upgraded waste heat can advantageously be used for district heating, which requires approximately 80 deg C. hot water.

Thus, the invention provides a method for recovering of waste heat created in the production of ammonia, the method comprises the steps of
(a) providing an ammonia synthesis gas including the steps of electrolysis of water or steam for the preparation of hydrogen and of adding a stream of nitrogen into the hydrogen;
(b) converting the ammonia synthesis gas to ammonia;
(c) recovering at least a part of waste heat from the electrolysis in step (a);
(d) upgrading the waste heat from step (c) by heat recovered from one or more compressor stages discharge and/or waste heat created in the conversion of the ammonia synthesis gas in step (b) and/or waste heat from a turbine condenser utilizing steam generated in step (b); and
(e) distributing the upgraded waste from step (d) to a downstream heat utilizing step.

Waste heat from the electrolysis is recovered by heating up circulating cooling water by indirect heat exchange. Part of the heated cooling water from the electrolysis is then upgraded by heat recovered from the conversion of the ammonia synthesis gas and/or waste heat from a turbine condenser.

The thus recovered heat is upgraded by heating the circulating cooling water from the electrolysis units to the required temperature by heat exchange with heat from heat recovered or created from the ammonia synthesis and/or turbine waste heat as mentioned above before heat exchange with the downstream heat utilizing step.

Waste from electrolysis at approximately 60° C. can be upgraded partially or maximized depending on season and the heat balance with the synthesis plant.

Synthesis gas compressor interstage waste heat is available for heating hot water to more than 80° C. Typical compressor discharge temperature is approximately 120-130° C.

The steam generated from waste heat from the ammonia synthesis reaction can be used e.g. in a steam turbine. The steam turbine condensation can take place at the required temperature for district heating to improve overall efficiency.

Additionally, steam generated from ammonia synthesis reaction heat can be used to produce power and district heating simultaneously just like in combined power and district heating plants. The ratio between power and district heating can be changed by the condenser temperature/pressure.

Ammonia can also be used as fuel for power production by use of gas turbine, gas engine or fuel cells.

The invention can advantageously combine and integrate the renewable power production with electro-fuels production and e.g., district heating.

The invention allows furthermore integration with other waste heat sources and can also be integrated with the renewable power production as it can be decided to produce power and/or electro-fuels and/or district heating.

This invention will require more heat exchangers, typically inexpensive, and thus complicate the overall process but the benefits would be paid back within short time.

The conversion of waste heat will unload the cooling requirements that can improve performance of the cooling system and consequently improve cooling to the process (compressor suction cooling) and thereby decrease the specific energy consumption.

Depending on the season more or less of the waste heat can be converted into district heating. The overall cooling system would anyhow be sized for the nominal plant load and without the requirement for district heating.

Further advantages of the invention are inter alia
Improving overall efficiency of the renewable power into electro-fuels if also district heating is produced;
reducing specific energy consumption by unloading cooling system when district heating is produced;
at low ammonia plant load the compressors will have to operate with kick back/antisurge system open and thereby increasing specific energy consumption. By recovering waste heat from the compressor interstage/discharge, the increase in specific energy consumption can be compensated and could become as in high plant load;
multiple variable system to optimize heat recovery for production of e-fuel, district heating and power.

In summary, preferred embodiments of the invention are the following either alone or in combination thereof:

The stream of nitrogen is obtained by air separation, pressure swing absorption or cryogenic air separation.

The downstream utilizing step comprises production of power in a gas turbine.

The production of power includes utilization of a part of the ammonia from step (b) as turbine fuel in the gas turbine. This can be preferably obtained by partially or fully cracking of ammonia to hydrogen and nitrogen.

The advantage, when using a gas turbine for power production is the flexibility with the steam turbine that can produce power and district heating depending on the season. Relative more power in summertime and less heat by operating the turbine at lower pressure. Thus, the downstream heat utilizing step includes district heating.

The downstream heat utilizing step is a combination of power production and district heating.

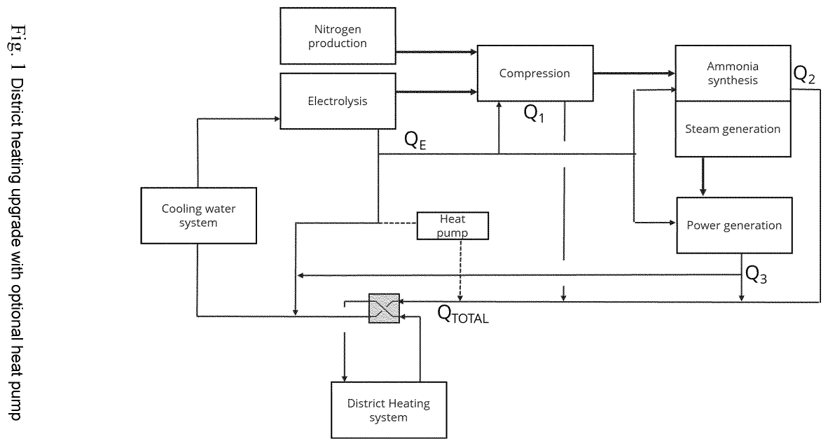

FIG. 1 shows the principle for how to produce district heating.

A closed cooling water circuit will supply cold cooling water (25 deg C.) to the electrolysis units, where it will be heated to 60 deg C. The temperature level at 60 deg C. is not sufficient for district heating, so a part of the hot cooling water will be upgraded to say 85 deg C. from three sources Q1, Q2 and Q3. Q1 is upper level heat from interstage compressor, Q2 is part of the process heat not used for steam generation, and Q3 is heat from the steam turbine condenser. Q3 is possible when the steam turbine condenser is operated at sufficiently high pressure though it results in lower power output from the steam turbine. Switching from summer to winter conditions will be by switching duty between Q2 and Q3.

The part of the heat from the electrolysis units for upgrade is QE. The remaining part can be upgrade by electricity with a heat pump if more district heating is required.

The upgraded hot cooling water at 85° C. from the three sources are mixed before entering the heat exchanger for district heating where it heats up the cold district water from say 30° C. to 82° C. The hot cooling water will be cooled to 33° C.

The cooling water system will remove the process heat that has not been transferred to the district heating system. The cooling water system will also supply cold cooling water to the process where required and is not shown in FIG. 1.

Table 1 gives an example of the amount of district heating that can be produced in a 2300 MTPD green ammonia plant without the option of a heat pump. The temperature levels are as given in the description of FIG. 1.

TABLE 1
Qtotal is the amount of district heating.

| 2300 MTPD | | |
|---|---|---|
| Green | | |
| Ammonia | | Heat energy |
| Q₁ | MW | 10 |
| Q₂ | MW | 10 |
| Q₃ | MW | 46 |
| Q_{upgrade} | MW | 66 |
| Q_{E} | MW | 71.3 |
| Qₜₒₜₐₗ | MW | 137.3 |

1. Method for recovering waste heat created in the production of ammonia, the method comprises the steps of
(a) providing an ammonia synthesis gas including the steps of electrolysis of water or steam for the preparation of hydrogen and of adding a stream of nitrogen into the hydrogen;
(b) converting the ammonia synthesis gas to ammonia;
(c) recovering at least a part of waste heat from the electrolysis in step (a);
(d) upgrading the waste heat from step (c) by heat recovered from one or more compressor stages discharge and/or waste heat created in the conversion of the ammonia synthesis gas in step (b) and/or waste heat from a turbine condenser utilizing steam generated in step (b); and
(e) distributing the upgraded waste heat from step (d) to a downstream heat utilizing step.

2. The method of claim 1, wherein the stream of nitrogen is obtained by air separation, pressure swing absorption or cryogenic air separation.

3. The method of claim 1, wherein the downstream utilizing step comprises production of power in a gas turbine.

4. The method of claim 3, wherein the production of power includes utilization of a part of the ammonia from step (b) as turbine fuel in the gas turbine, gas engine or fuel cell.

5. The method of claim 4, wherein the ammonia is at least partially cracked to hydrogen and nitrogen.

6. The method of claim 1, wherein the downstream heat utilizing step includes district heating.

7. The method of claim 1, wherein the downstream heat utilizing step is a combination of power production and district heating.

8. The method of claim 1, wherein the upgrading of the waste heat in step (d) is performed by heating a circulating cooling water from the electrolysis by heat exchange with heat recovered or created from the ammonia synthesis and/or turbine waste heat from a turbine condenser utilizing steam generated in step (b).
